(19) United States
(12) Patent Application Publication
(10) Pub. No.: US 2018/0232615 A1
(43) Pub. Date: Aug. 16, 2018

(54) PORTABLE DATA CARRIER, IN PARTICULAR A CHIP CARD

(71) Applicant: GIESECKE+DEVRIENT MOBILE SECURITY GMBH, München (DE)

(72) Inventors: Thomas TARANTINO, Laufen (DE); Sascha BEHLENDORF, Ebersberg (DE); Werner STROBL, München (DE); Rodrigue GIL, München (DE); Florian GAWLAS, München (DE)

(21) Appl. No.: 15/751,950

(22) PCT Filed: Aug. 9, 2016
(86) PCT No.: PCT/EP2016/001365

§ 371 Date: Feb. 12, 2018

(30) Foreign Application Priority Data
Aug. 11, 2015 (DE) 10 2015 010 458.6

(51) Int. Cl. G06K 19/073; G06K 19/077; G07F 7/08; G06K 19/07

(52) U.S. Cl. CPC G06K 19/07372; G06K 19/0717; G07F 7/082; G06K 19/07701

(57) ABSTRACT

A portable data carrier, in particular a chip card, comprises one or several sensors which are respectively arranged for detecting via the capture of measurement values a laying open of a surface of the portable data carrier as a detection event. It further comprises one or several output means for outputting signals perceptible by a user. The data carrier according to the invention is wherein it is arranged for outputting a signal via the one or more output means upon satisfaction of a detection criterion, the detection criterion being satisfied when the detection event is detected by at least a part of the sensors.

### BACKGROUND

The invention relates to a portable data carrier and in particular to a chip card, such as e.g. a smart card.

Portable data carriers and in particular chip cards are employed in a plurality of areas of application. Such data carriers often serve for carrying out monetary transactions. The problem here is that the portable data carrier is often not used by a user, although the user carries the portable data carrier with him.

The print GB 2 407 189 A discloses a smart card whose activation is linked with detection events which are detected by different sensors on the card, such as e.g. by a light sensor, a pressure sensor, a thermal sensor, and the like.

### SUMMARY

The object of the invention is to create a portable data carrier and in particular a chip card having enhanced functionality compared with conventional portable data carriers.

The portable data carrier according to the invention, which is in particular a chip card, comprises one or several sensors which are respectively arranged for detecting via the capture of measurement values a laying open of a surface of the (previously covered) portable data carrier as a detection event. In this way, with the one or more sensors there can be detected the removing of the portable data carrier from a storage medium, such as e.g. a wallet, or the opening of a corresponding storage medium with a portable data carrier contained therein.

The data carrier according to the invention further comprises one or several output means for outputting signals perceptible by a user. The data carrier here is arranged for outputting a signal via the one or more output means upon satisfaction of a detection criterion, the detection criterion being satisfied when the detection event is detected by at least a part of the sensors.

The data carrier according to the invention has the advantage that with an upcoming use of the data carrier the user's attention is drawn to the presence of the data carrier, i.e. with opening a storage medium with a data carrier contained therein or with removing the data carrier from the storage medium, which increases the usage of the data carrier. The invention is advantageous particularly for such portable data carriers or chip cards which lie on the top in the card pocket of the wallet of a user, because in this case the user immediately recognizes the presence of the portable data carrier through a respective output of the one or more output means.

The portable data carrier according to the invention can be provided for various purposes of use. In preferred variants, the portable data carrier is a card for carrying out monetary transactions, such as e.g. a credit card or another bank card. Likewise, the portable data carrier can be a card for ticket reservation and/or a card for a user's access authorization and/or a security element.

In a further preferred variant, the one or more sensors of the portable data carrier comprise at least one light sensor which is configured such that during operation it captures brightness values of the surroundings around the portable data carrier as measurement values and detects as a detection event that a change of the brightness values satisfies a predetermined condition. The light sensor detects as a detection event in particular that the brightness values exceed a predetermined threshold or that the amount of temporal change of the brightness values exceeds a predetermined threshold in a predetermined time period. This allows the event of the laying open of a surface of the portable data carrier and thus the opening of a storage medium with a data carrier contained therein or the removing of the data carrier from the storage medium to be captured simply and cost-efficiently.

Alternatively or additionally, the one or more sensors may comprise at least one first sound sensor which is configured such that during operation it captures loudness values as measurement values, which are generated by the surroundings around the first sound sensor. This first sound sensor detects here as a detection event that a change of the loudness values satisfies a predetermined condition. The sound sensor detects as a detection event in particular that the loudness values exceed a predetermined threshold or that the amount of temporal change of the loudness values exceeds a predetermined threshold in a predetermined time period. In this variant, surrounding noises which were not generated by the portable data carrier itself are used for detecting the detection event.

In a further variant of the portable data carrier according to the invention, the one or more sensors comprise at least one-second sound sensor which is configured such that during operation it captures loudness values as measurement values, which are generated by at least one sound generator of the portable data carrier. As a detection event the second sound sensor detects that a change of the loudness values satisfies a predetermined condition. The first sound sensor detects as a detection event in particular that the loudness values undershoot a predetermined threshold or that the amount of temporal change of the loudness values exceeds a predetermined threshold in a predetermined time period. From this there can be inferred that the sound waves sent out by the sound generator are no longer reflected directly at an area of a storage medium which means that the storage medium with the portable data carrier contained therein was opened or the portable data carrier was removed therefrom.

In a further preferred variant, the one or more sensors comprise at least one temperature sensor which is configured such that during operation it captures temperature values of the surroundings around the temperature sensor as measurement values. The temperature sensor here detects as a detection event that a change of the temperature values satisfies a predetermined condition. The temperature sensor detects as a detection event in particular that the temperature values exceed a predetermined threshold or that the amount of the temporal change of the temperature values exceeds a predetermined threshold in a predetermined time period, from which it can be inferred that the portable data carrier was removed from a storage medium or the storage medium with the portable data carrier contained therein was opened.

Depending on the embodiment, the output means provided in the portable data carrier can be configured in different ways. In one variant, the one or more output means comprise a visual output means, in particular one or several LEDs and, where applicable, also a display or a different visual output means. Alternatively or additionally, as an output means there can also be integrated an acoustic output means, i.e. a corresponding loudspeaker, in the portable data carrier.

In a further variant of the data carrier according to the invention, the above detection criterion is satisfied when the detection event is detected by only one single (arbitrary) sensor. In this way, a quick reaction of the portable data carrier in response to the detection event is ensured.

In a further variant, the portable data carrier comprises several sensors, the detection criterion being satisfied only when the detection event is detected by all of the several sensors. In other words, an output via the one or more output means is not effected when only a part of the sensors detects the detection event. This ensures a reliable functionality of the portable data carrier.

In a further variant of the data carrier according to the invention, the detection criterion is the criterion to be exclusively satisfied for the output of a signal via the one or more output means. No further criteria, such as e.g. the presence of a reading field or the like, are thus taken into account. This realizes a simple check of the detection criterion in the portable data carrier.

In a further variant of the invention, furthermore, one or several (further) functions of the portable data carrier are activated when the detection criterion is satisfied, beside the output of a signal via the one or more output means. In particular, the one or more functions comprise a communication function of the portable data carrier with an external device, preferably a contactless communication function. Therefore, respective functions of the portable data carrier are released only when the usage of the portable data carrier by a user is actually coming up. In this way, an abusive use of the portable data carrier by a third party can be avoided. Furthermore, the energy consumption of the portable data carrier is lowered.

### BRIEF DESCRIPTION OF THE DRAWINGS

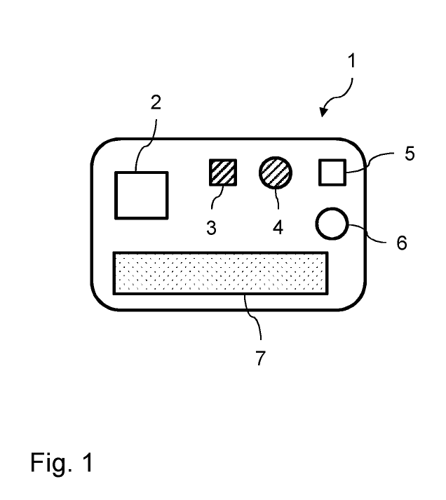

An embodiment example of the invention will hereinafter be described in detail with reference to the attached FIG. 1. This Figure shows in a schematic representation a variant of a portable data carrier according to the invention.

### DETAILED DESCRIPTION OF VARIOUS EMBODIMENTS

In the following, the invention will be described with reference to a portable data carrier in the form of a chip card 1. The chip card includes a microprocessor unit which is integrated in a chip 2 of the card. In the embodiment described here the chip card is a card for carrying out monetary transactions (e.g. a credit card), these transactions being controlled via the microprocessor unit. For this purpose, the chip card preferably comprises a contactless interface (not shown) which communicates with a corresponding reading device, via this communication the monetary transactions being prompted.

In the embodiment of FIG. 1, the chip card 1 comprises in the upper region a light sensor 3 as well as a sound sensor in the form of a microphone 4. There are additionally provided an optical output means in the form of an LED 5 and/or a display device (display) as well as an acoustic output means in the form of a loudspeaker 6. As schematically indicated by the dotted field 7, the card has applied thereon information in a corresponding text field, in particular the name of the card owner as well as the card number and the expiry date of the card.

By means of the two sensors 3 and 4 the laying open of a surface of the card and thus the opening of a storage medium with a card contained therein or the removal of the card from the storage medium is captured by the card 1. To obtain this, the light sensor 3 detects the event that the surrounding brightness captured by this sensor exceeds a predetermined threshold value. Analogously, the microphone 4 detects the event that the surrounding loudness captured by said microphone exceeds a predetermined threshold.

As soon as one or, where applicable, both of the sensors 3 and 4 detect the respective event of a threshold value being exceeded, this leads to a lighting up of the LED 5 or, alternatively or additionally, to the output of an acoustic signal via the loudspeaker 6. In this way, a user who opens his wallet for a payment operation is made aware of the presence of a credit card which he can employ for the payment operation. This achieves an increased usage of the credit card by the user.

In a further modified embodiment, instead of or in addition to the sound sensor 4 there is provided a further sound sensor which interacts with a sound generator (not shown) on the card. Here, the card actively, e.g., periodically, sends out sound waves via the sound generator and measures the returning signal. If this changes on account of the opening of a storage medium with a card located therein or on account of the removal of the card from the storage medium, a corresponding signal is output to the user again via the LED 5, the display device (not shown) and/or the loudspeaker 6. The signal is generated in particular when the sound waves detected via the further sound sensor undershoot a predetermined threshold, because this suggests that the sound waves are no longer reflected directly at the corresponding storage medium.

In a further modified embodiment, in addition to or instead of the sensors 3 and 4 there can also be used a temperature sensor, again the LED 5 and/or the display device being switched on or an acoustic signal being generated by the loudspeaker 6 when temperature changes occur.

In a further preferred embodiment, the detection event of the surface of the card being laid open is linked with the activation of predetermined functionalities of the card. In particular, the contactless interface of the card, which is described above, is activated only when the detection event was captured. This avoids an abusive use of the card by unauthorized third parties. Likewise, the activation of a display or of a fingerprint sensor on the card can be effected only upon the occurrence of the detection event. This reduces the energy consumption of the card, because certain functions are switched on only upon the usage of said card.

The hereinabove described embodiments of the invention have a number of advantages. In particular, the user of the card is made aware of the card by an optical or acoustic signal, when he removes the card from a storage medium and in particular his wallet. This increases the use of the card and its acceptance by the user. Moreover, in special embodiments, the energy consumption of the card can be reduced or the abusive use thereof can be avoided, by certain functionalities of the card being enabled only when it is removed from a storage medium.

1-12. (canceled)

13. A portable data carrier, comprising:
one or several sensors which are respectively arranged for detecting via the capture of measurement values a laying open of a surface of the portable data carrier as a detection event;
one or several output means for outputting signals perceptible by a user;
wherein the portable data carrier is arranged for outputting a signal via the one or more output means upon satisfaction of a detection criterion,
wherein the detection criterion is satisfied when the detection event is detected by at least a part of the sensors.

14. The portable data carrier according to claim 13, wherein the portable data carrier is a card for carrying out monetary transactions and/or a card for ticket reservation and/or a card for a user's access authorization and/or a security element.

15. The portable data carrier according to claim 13, wherein the one or more sensors comprise at least one light sensor which is configured such that during operation it captures brightness values of the surrounding brightness around the portable data carrier as measurement values and detects as a detection event that a change of the brightness values satisfies a predetermined condition.

16. The portable data carrier according to claim 13, wherein the one or more sensors comprise at least one first sound sensor which is configured such that during operation it captures loudness values which are generated by the surroundings around the first sound sensor as measurement values and that it detects as a detection event that a change of the loudness values satisfies a predetermined condition.

17. The portable data carrier according to claim 13, wherein the one or more sensors comprise at least one second sound sensor which is configured such that during operation it captures loudness values which are generated by at least one sound generator of the portable data carrier as measurement values and that it detects as a detection event that a change of the loudness values satisfies a predetermined condition.

18. The portable data carrier according to claim 13, wherein the one or more sensors comprise at least one temperature sensor which is configured such that during operation it captures temperature values of the surroundings around the temperature sensor as measurement values and detects as a detection event that a change of the temperature values satisfies a predetermined condition.

19. The portable data carrier according to claim 13, wherein the one or more output means comprise a visual output means, in particular one or several LEDs, a display device, and/or an acoustic output means.

20. The portable data carrier according to claim 13, wherein the detection criterion is satisfied when the detection event is detected by one single sensor.

21. The portable data carrier according to claim 13, wherein the portable data carrier comprises several sensors and the detection criterion is satisfied when the detection event is detected by all of the several sensors.

22. The portable data carrier according to claim 13, wherein the detection criterion is the criterion to be exclusively satisfied for the output of a signal via the one or more output means.

23. The portable data carrier according to claim 13, wherein upon satisfaction of the detection criterion further one or several functions of the portable data carrier are activated.

24. The portable data carrier according to claim 23, wherein the one or more functions comprise a communication function of the portable data carrier with an external device, in particular a contactless communication function.
